(19) United States
(12) Patent Application Publication
(10) Pub. No.: US 2025/0003753 A1
(43) Pub. Date: Jan. 2, 2025

(54) INFORMATION PROCESSING DEVICE

(71) Applicant: NTT DOCOMO, INC., Tokyo (JP)

(72) Inventors: Masashi ANZAWA, Tokyo (JP); Masaki MORISHITA, Tokyo (JP); Hiroki ISHIZUKA, Tokyo (JP); Keisuke NAKASHIMA, Tokyo (JP)

(21) Appl. No.: 18/689,184

(22) PCT Filed: Jul. 27, 2022
(86) PCT No.: PCT/JP2022/028869

§ 371 Date: Mar. 5, 2024

(30) Foreign Application Priority Data
Sep. 17, 2021 (JP) 2021-152036

(51) Int. Cl. G01C 21/20; G01C 21/00

(52) U.S. Cl. CPC G01C 21/20; G01C 21/005

(57) ABSTRACT

A prediction unit predicts an illuminance limit time (LT) at which an illuminance of an area in which a drone flies falls below a threshold value, based on an illuminance acquired by an acquisition unit, and predicts a remaining time (ST) from a current time (NT) to the illuminance limit time (LT). A comparison unit (compares the remaining time (ST) predicted by the prediction unit with a future scheduled flight time (FT) included in the flight plan information for the drone in accordance with the above-described method. A changing unit changes the flight plan information for the drone when the remaining time (ST) is considered insufficient compared to the future scheduled flight time (FT), so that the future scheduled flight time (FT) is no greater than the remaining time (ST).

### TECHNICAL FIELD

The present invention relates to a technique for performing flight control in accordance with the brightness of an area in which a flight vehicle is flying.

### BACKGROUND

Services that use unmanned flight vehicles, called drones, to transport packages, for example, have been launched. These unmanned flight vehicles may have difficulty flying at night. Therefore, in Japan, for example, there are restrictions on flying after sunset. For example, JP 2017-119502A discloses, as a mechanism for performing a control in accordance with brightness in the flight environment, a mechanism with which, when an unmanned flight vehicle enters a building or tunnel, the illuminance in the direction of travel is detected using an illuminance sensor installed on the unmanned flight vehicle, and the unmanned flight vehicle is prohibited from flying in the direction of travel if the detected illuminance does not meet a permitted illuminance.

### SUMMARY OF INVENTION

An object of the present invention is to provide a mechanism that enables a flight vehicle to fly in accordance with the time until the illuminance in flight becomes insufficient.

The present invention provides an information processing apparatus including: a prediction unit that predicts a time at which an illuminance of an area in which a flight vehicle flies will fall below a threshold value; a comparison unit that compares a time remaining until the predicted time with a flight time scheduled after a current time included in a flight plan for the flight vehicle; and a changing unit that changes the flight plan for the flight vehicle when the time remaining is insufficient compared to the scheduled flight time.

The present invention enables a flight vehicle to fly in accordance with the time until the illuminance in flight becomes insufficient.

### BRIEF DESCRIPTION OF DRAWINGS

FIG. 1 is a block diagram showing an example of a configuration of drone management system 1 according to an embodiment of the present invention.

FIG. 2 is a block diagram showing an example of a hardware configuration of drone 10 according to one embodiment.

FIG. 3 is a block diagram showing an example of a hardware configuration of server apparatus 50 according to one embodiment.

FIG. 4 is a block diagram showing an example of a functional configuration of drone 10, according to one embodiment.

FIG. 5 is a diagram illustrating chronological changes in illuminance over the course of a day in one embodiment.

FIG. 6 is a diagram illustrating the remaining time from the current time to an illuminance limit time LT in one embodiment.

FIG. 7 is a diagram illustrating the remaining time from the current time to illuminance limit time LT in one embodiment.

FIG. 8 is a diagram illustrating a mechanism for predicting illuminance limit time LT in one embodiment.

FIG. 9 is a diagram illustrating an example in which the flight plan for drone 10 is changed in accordance with the remaining time in the embodiment.

FIG. 10 is a flowchart illustrating processing steps performed by drone 10 in one embodiment.

FIG. 11 is a diagram illustrating a mechanism for predicting illuminance limit time LT in accordance with the weather in a modification.

### DETAILED DESCRIPTION

### Configuration

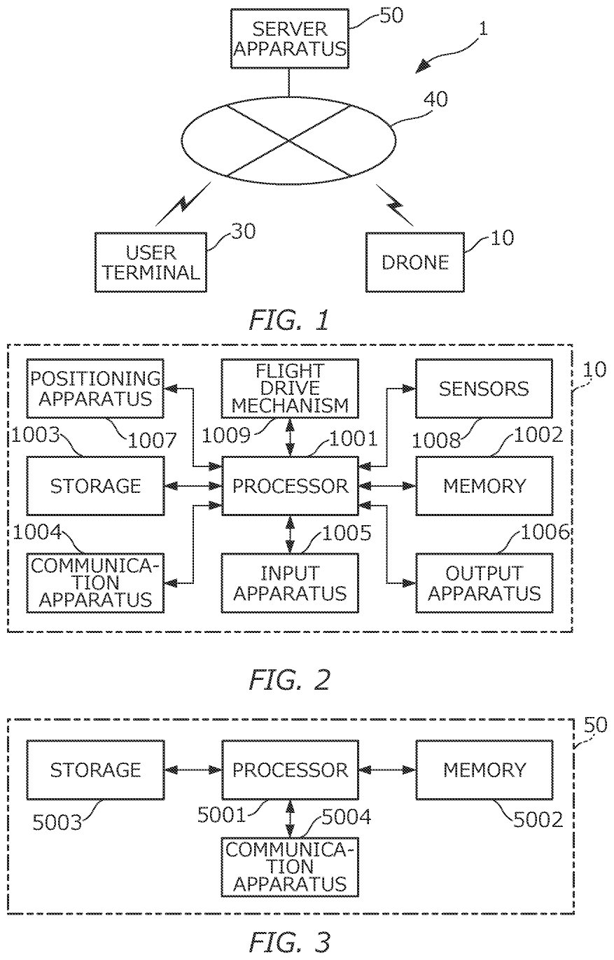

FIG. 1 is a diagram showing an example of a configuration of drone management system 1 according to an embodiment of an information processing system according to the present invention. Drone management system 1 includes drone 10 that transports a package to a destination, user terminal 30 used by a user residing in a dwelling unit that is the destination of drone 10, wireless communication network 40, and server apparatus 50 connected to wireless communication network 40. Although FIG. 1 shows a single drone 10, a single user terminal 30, a single wireless communication network 40, and a single server apparatus 50, there may be a plurality of each.

Drone 10 is an unmanned flight vehicle that flies in the air. Drone 10 transports a package by flying to the destination while holding the package, and landing at the destination.

User terminal 30 is, for example, a communicable computer such as a smartphone, a tablet, or a personal computer. In the present embodiment, user terminal 30 is a smartphone, and functions as a communication terminal through which the user receiving a package receives various notifications from server apparatus 50 and accesses server apparatus 50 via wireless communication network 40.

Wireless communication network 40 may be, for example, equipment compliant with the fourth-generation mobile communication system, or equipment compliant with the fifth-generation mobile communication system. Drone 10, user terminal 30, and server apparatus 50 communicate with each other via wireless communication network 40.

Server apparatus 50 stores pieces of flight plan information such as flight date and time, a flight route, and a flight altitude of drone 10, and remotely controls drone 10 in accordance with the pieces of flight plan information. The remote control by server apparatus 50 is mainly performed in the section between the departure and arrival point of drone 10, called the base, and an area above the destination of drone 10. Drone 10 flies under autonomous control by drone 10 itself in the section between the area above the destination and the landing point of drone 10.

In the present embodiment, as described above, the drone relies on the remote control by server apparatus 50 in the section between the departure and arrival point and the area above the destination of the drone, and flies autonomously in the section between the area above the destination and the landing position of the drone. However, the present invention is not limited to this example. For example, drone 10 may autonomously fly all of the sections between the departure and arrival point and the landing position at the destination without relying on the remote control by server apparatus 50, or fly under the remote control by server apparatus 50 in all of the sections between the departure and arrival point and the landing position at the destination. Alternatively, drone 10 may be manually controlled by an operator using a control terminal.

FIG. 2 is a diagram showing an example of a hardware configuration of drone 10. Drone 10 is formed as a computer apparatus physically including processor 1001, memory 1002, storage 1003, communication apparatus 1004, input apparatus 1005, output apparatus 1006, positioning apparatus 1007, sensors 1008, flight drive mechanism 1009, a bus connecting these components, and so on. In the following description, the term “apparatus” can be read as circuit, device, unit, or the like. In the hardware configuration of drone 10, each of the apparatuses shown in the figure may be provided in singularity or in plurality, and some of the apparatuses may be omitted.

Each function of drone 10 is realized by loading predetermined software (programs) into hardware such as processor 1001 and memory 1002 so that processor 1001 performs computations to control communication performed by communication apparatus 1004, to control at least either reading data from or writing data to memory 1002 and storage 1003, or to control positioning apparatus 1007, sensors 1008, and flight drive mechanism 1009.

Processor 1001 runs an operating system to control the entire computer, for example. Processor 1001 may be constituted by a central processing unit (CPU) that includes an interface with a peripheral apparatus, a control apparatus, a computation apparatus, a register, and so on. In addition, for example, a baseband signal processing unit, a call processing unit, and so on may be realized by processor 1001.

Processor 1001 reads out programs (program codes), software modules, data, and so on from at least one of storage 1003 and communication apparatus 1004 into memory 1002 and performs various kinds of processing in accordance with the programs. Programs that enable a computer to execute at least some of the operations described below are used as the aforementioned programs. The functional blocks of drone 10 may be realized by control programs stored in memory 1002 and executed by processor 1001. The various kinds of processing may be performed by a single processor 1001, but may also be performed by two or more processors 1001 simultaneously or sequentially. Processor 1001 may be implemented using one or more chips. The programs may be transmitted to drone 10 via wireless communication network 40.

Memory 1002 is a computer-readable recording medium, and may be constituted by at least one of a ROM, an EPROM (Erasable Programmable ROM), an EEPROM (Electrically Erasable Programmable ROM), a RAM, and so on. Memory 1002 may also be referred to as a register, a cache, a main memory (main storage apparatus), or the like. Memory 1002 is capable of storing executable programs (program codes), software modules, and so on to implement the method according to the present embodiment.

Storage 1003 is a computer-readable recording medium, and may be constituted by at least one of an optical disk such as a CD-ROM (Compact Disc ROM), a hard disk drive, a flexible disk, a magneto-optical disk (for example, a compact disk, a digital versatile disk, or a Blu-ray (registered trademark) disk), a smart card, a flash memory (for example, a card, a stick, or a key drive), a floppy (registered trademark) disk, a magnetic strip, and so on. Storage 1003 may also be referred to as an auxiliary storage apparatus. Storage 1003 stores various programs and a data group.

Processor 1001, memory 1002, and storage 1003 described above function as an example of the information processing apparatus according to the present invention.

Communication apparatus 1004 is hardware (a transmission and reception device) for communication between computers via wireless communication network 40, and is also referred to as, for example, a network device, a network controller, a network card, a communication module, or the like. Communication apparatus 1004 includes a high frequency switch, a duplexer, a filter, a frequency synthesizer, and so on in order to realize frequency division duplexing and time division duplexing. A transmission and reception antenna, an amplifier unit, a transmission and reception unit, a propagation path interface, and so on may be realized by communication apparatus 1004. The transmission and reception unit may be implemented as a transmitting unit and a receiving unit that are physically or logically separated from each other.

Input apparatus 1005 is an input device that accepts input from an external apparatus, and examples thereof include keys, switches, microphones, and so on. Output apparatus 1006 is an output device that performs output to an external apparatus, and examples thereof include a display apparatus such as a liquid crystal display, a speaker, and so on. Input apparatus 1005 and output apparatus 1006 may be integrated.

Positioning apparatus 1007 is hardware for measuring the position of drone 10, and is a GPS (Global Positioning System) device, for example. Drone 10 flies from the departure and arrival point to the area above the destination based on positioning by positioning apparatus 1007.

Sensors 1008 include various sensors such as an illuminance sensor that functions as an illuminance detection means for detecting the brightness (illuminance) around drone 10, as well as various sensors necessary for the flight of drone 10, such as a ranging sensor, a gyro sensor, a direction sensor, and an image sensor. Note that sensors 1008 may also include a sensor that detects the position, shape, or size of a targeted object, using, for example, a technology called LiDAR (Light Detection and Ranging, Laser Imaging Detection and Ranging) or a technology called SLAM (Simultaneous Localization and Mapping).

Flight drive mechanism 1009 includes hardware such as a motor and a propeller for drone 10 to fly.

The apparatuses such as processor 1001 and memory 1002 are connected by a bus for information communication. The bus may be constituted by a single bus or formed using a different bus for each pair of apparatuses. In addition, drone 10 may include hardware such as a microprocessor, a GPU (Graphics Processing Unit), a digital signal processor (DSP), an ASIC (Application Specific Integrated Circuit), a PLD (Programmable Logic Device), an FPGA (Field Programmable Gate Array), and so on, and part or all of each functional block may be realized by such hardware. For example, processor 1001 may be implemented using at least one of these pieces of hardware.

FIG. 3 is a diagram showing a hardware configuration of server apparatus 50. In the hardware configuration of server apparatus 50, each of the apparatuses shown in FIG. 3 may be provided in singularity or in plurality, and some of the apparatuses may be omitted. Alternatively, server apparatus 50 may be formed by communicatively connecting a plurality of apparatuses each having a different housing.

Server apparatus 50 is formed as a computer apparatus physically including processor 5001, memory 5002, storage 5003, communication apparatus 5004, a bus connecting these components, and so on. Each function of server apparatus 50 is realized by loading predetermined software (programs) into hardware such as processor 5001 and memory 5002 so that processor 5001 performs computations to control communication performed by communication apparatus 5004, or to control at least either reading data from or writing data to memory 5002 and storage 5003. These apparatuses are powered by a power source (not shown).

Processor 5001 runs an operating system to control the entire computer, for example. Processor 5001 may be constituted by a central processing unit (CPU) that includes an interface with a peripheral apparatus, a control apparatus, a computation apparatus, a register, and so on. In addition, for example, a baseband signal processing unit, a call processing unit, and so on may be realized by processor 5001.

Processor 5001 reads out programs (program codes), software modules, data, and so on from at least one of storage 5003 and communication apparatus 5004 into memory 5002 and performs various kinds of processing in accordance with the programs. Programs that enable a computer to execute at least some of the operations described below are used as the aforementioned programs. The functional blocks of server apparatus 50 may be realized by control programs stored in memory 5002 and executed by processor 5001. The various kinds of processing may be performed by a single processor 5001, but may also be performed by two or more processors 5001 simultaneously or sequentially. Processor 5001 may be implemented using one or more chips.

Memory 5002 is a non-transitory, computer-readable recording medium, and may be constituted by at least one of a ROM, an EPROM, an EEPROM, a RAM, and so on. Memory 5002 may also be referred to as a register, a cache, a main memory (main storage apparatus), or the like. Memory 5002 is capable of storing executable programs (program codes), software modules, and so on to implement the method according to the present embodiment.

Storage 5003 is a non-transitory, computer-readable recording medium, and may be constituted by at least one of an optical disk such as a CD-ROM, a hard disk drive, a flexible disk, a magneto-optical disk (for example, a compact disk, a digital versatile disk, or a Blu-ray (registered trademark) disk), a smart card, a flash memory (for example, a card, a stick, or a key drive), a floppy (registered trademark) disk, a magnetic strip, and so on. Storage 5003 may also be referred to as an auxiliary storage apparatus. Storage 5003 stores programs and data groups used to perform the various kinds of processing described below. The data groups stored in storage 5003 include flight plan information for drone 10.

Communication apparatus 5004 is hardware (a transmission and reception device) for communication between computers via wireless communication network 40, and is also referred to as, for example, a network device, a network controller, a network card, a communication module, or the like.

The apparatuses such as processor 5001 and memory 5002 are connected by a bus for information communication. The bus may be constituted by a single bus or formed using a different bus for each pair of apparatuses.

Server apparatus 50 may include hardware such as a microprocessor, a digital signal processor, an ASIC, a PLD, an FPGA, and so on, and part or all of each functional block may be realized by such hardware. For example, processor 5001 may be implemented using at least one of these pieces of hardware.

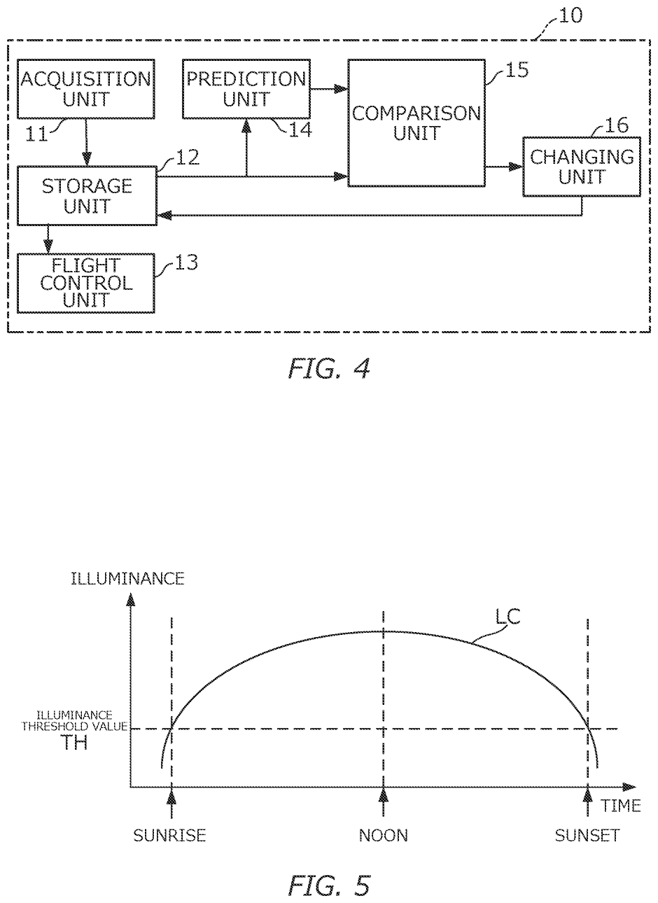

FIG. 4 is a diagram illustrating a functional configuration of drone 10. As shown in FIG. 4, the respective functions of acquisition unit 11, storage unit 12, flight control unit 13, prediction unit 14, comparison unit 15, and changing unit 16 are realized in drone 10.

Acquisition unit 11 acquires various kinds of data from positioning apparatus 1007, sensors 1008, server apparatus 50, and so on. For example, acquisition unit 11 acquires the illuminance detected by sensors 1008. Acquisition unit 11 also acquires flight plan information from server apparatus 50 via wireless communication network 40.

Storage unit 12 stores the data groups acquired by acquisition unit 11, as well as programs and data groups used to execute the various kinds of processing described below.

Flight control unit 13 uses the flight plan information stored in storage unit 12 and the various kinds of data sensed by sensors 1008 to control flight drive mechanism 1009 and realize the flight of drone 10.

Prediction unit 14 predicts the time at which the illuminance of the area in which drone 10 flies falls below the threshold value. Here, FIG. 5 is a diagram illustrating chronological changes in illuminance over the course of a day. In FIG. 5, the horizontal axis represents the time and the vertical axis represents the illuminance. For example, assuming that the weather remains clear and unchanged throughout the day, illuminance curve LC, which represents the change in illuminance at a given point on the ground, rises rapidly from sunrise, reaches its maximum at noon, and falls rapidly at sunset. Here, for example, the illuminance at sunset is set as a threshold value (hereinafter referred to as illuminance threshold value TH). Drone 10 is allowed to fly if the illuminance on the ground is equal to or above illuminance threshold value TH, and drone 10 is restricted from flying if the illuminance on the ground is below illuminance threshold value TH. In other words, if the illuminance on the ground is below illuminance threshold value TH, it is determined that the illuminance is insufficient for drone 10 to fly safely.

Prediction unit 14 predicts the time at which the illuminance of the area in which drone 10 flies falls below a threshold value (hereinafter referred to as illuminance limit time LT) based on the illuminance detected by sensor 1008 (an illuminance sensor) included in drone 10.

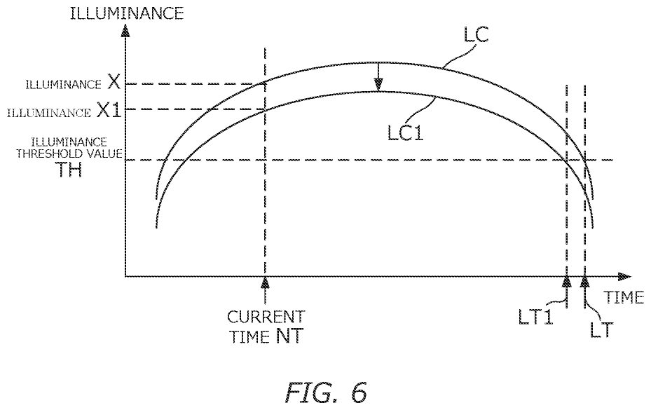

Here, FIG. 6 is a diagram illustrating a mechanism for predicting illuminance limit time LT. In FIG. 5 above, it is assumed that the weather remains clear and unchanged, but in reality, there are various weather conditions such as cloudy and rainy. Illuminance curve LC in FIG. 6 is equivalent to illuminance curve LC in FIG. 5. For example, at current time NT, the illuminance should be X according to illuminance curve LC, but if the illuminance actually detected by sensor 1008 is X1 (X1<X), prediction unit 14 translates illuminance curve LC downward until the illuminance at current time NT is X1 to obtain illuminance curve LC1. Here, in the moved illuminance curve LC1, the time at which the illuminance falls below illuminance threshold value TH is illuminance limit time LT1 (LT1<LT). Thus, although the illuminance limit time according to illuminance curve LC should be LT, the predicted illuminance limit time is LT1. In this way, prediction unit 14 predicts the illuminance limit time by moving illuminance curve LC in the two-dimensional time-illuminance plane.

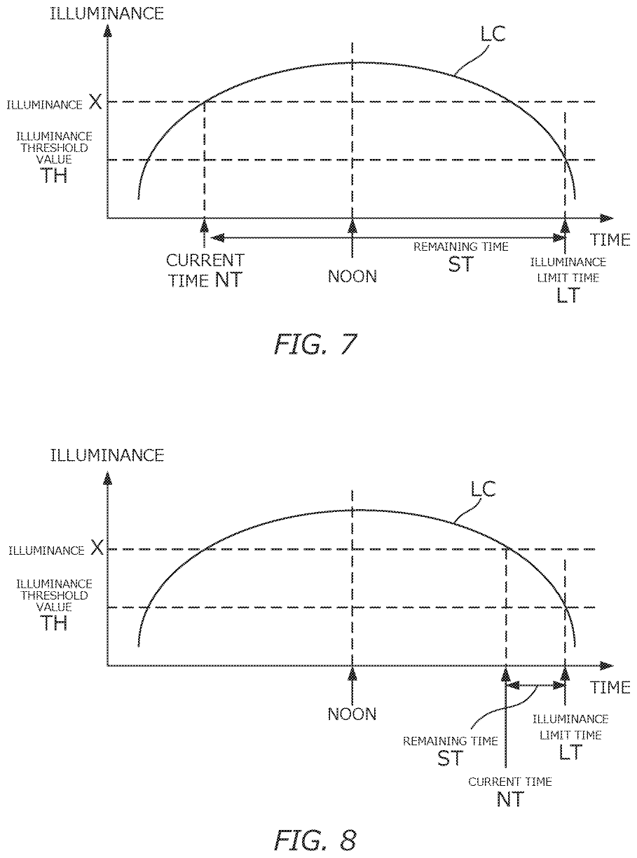

Furthermore, prediction unit 14 calculates the remaining time from current time NT to illuminance limit time LT. Here, FIGS. 7 and 8 are diagrams illustrating the remaining time from the current time to illuminance limit time LT (i.e., until the illuminance becomes insufficient for drone 10 to fly safely), and illuminance curve LC shown in these figures is the illuminance curve moved in the manner described for FIG. 6. In FIG. 7, it is assumed that the illuminance detected by sensor 1008 when current time NT is before noon is illuminance X, for example. In this case, the point in time corresponding to illuminance X in the section before noon of illuminance curve LC is current time NT, and therefore, the remaining time (remaining time ST) is the time from current time NT to the time at which illuminance threshold value TH is reached in the section after noon of illuminance curve LC (illuminance limit time LT).

In FIG. 8, it is assumed that the illuminance detected by sensor 1008 when current time NT is after noon is illuminance X, for example. In this case, the point in time corresponding to illuminance X in the section after noon of illuminance curve LC is current time NT, and therefore, the remaining time (remaining time ST) is the time from current time NT to the time at which illuminance threshold value TH is reached in the section after noon of illuminance curve LC (illuminance limit time LT). In the manner described above, the remaining time for drone 10 to fly safely can be determined.

Now, FIG. 4 is referenced again. Comparison unit 15 compares remaining time ST predicted by prediction unit 14 with future scheduled flight time FT included in the flight plan information for drone 10. The future scheduled flight time mentioned here is the scheduled flight time required for drone 10 to carry out the flight plan from the current time to the end of the flight, included in the daily flight plan for drone 10.

Changing unit 16 changes the flight plan for drone 10 when remaining time ST is considered insufficient compared to future scheduled flight time FT. The case in which remaining time ST is considered insufficient compared to future scheduled flight time FT is, for example, a case in which remaining time ST is less than scheduled flight time FT (ST<FT). However, from a safety perspective, remaining time ST may be considered insufficient compared to future scheduled flight time FT when a condition ST<α×FT or a condition ST<FT−β is satisfied, using predetermined coefficient α (0<α<1) or constant β (β: positive number).

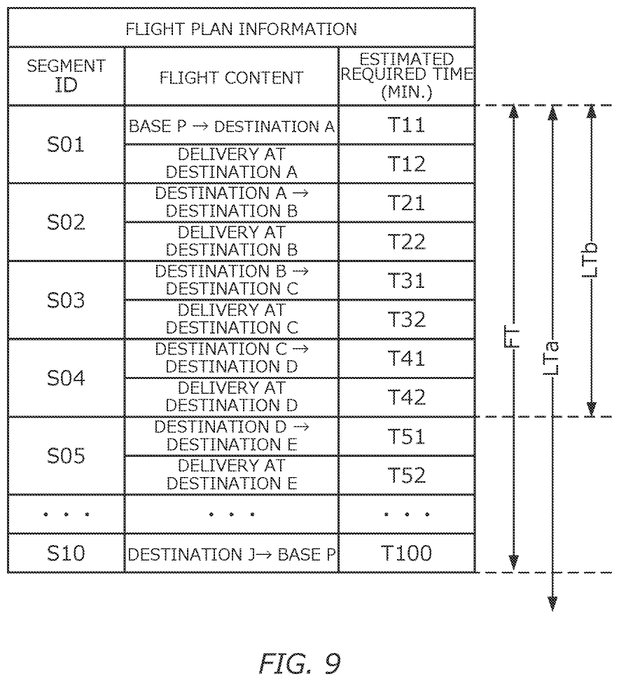

Here, FIG. 9 is a diagram illustrating an example in which the flight plan for drone 10 is changed in accordance with the remaining time. The flight plan indicated by the flight plan information contains a plurality of subplans called segments. The present embodiment describes an example in which drone 10 transports packages, and therefore each segment is equivalent to a plan for transportation of a package. In the example in FIG. 9, drone 10 transports a package to each destination, e.g., drone 10 flies from base P to destination A in the segment with segment ID “S01” and delivers a package at destination A, flies to destination B in the segment with segment ID “S02” and delivers a package at destination B, flies to destination C in the segment with segment ID “S03” and delivers a package at destination C, and so on, and drone 10 thereafter flies from destination J back to base P in the segment with segment ID “S10”.

In the flight plan information, the time required to travel from a base or destination to the next destination can be obtained by dividing the distance of that travel by the average speed of drone 10, or based on historical records, for example. Similarly, the time required for delivery at the destination (i.e., the time required to deliver the package to be transported by drone 10, from the area above the destination to the destination) may also be based on historical records. In other words, if any packages have been transported at a destination in the past, server apparatus 50 or drone 10 stores the time required to deliver the package to be transported by drone 10, from the area above the destination to the destination (for example, a dwelling unit), and uses the required time to create and change the flight plan information. If no packages have been transported at a destination in the past, server apparatus 50 or drone 10 averages the times required for drone 10 to deliver packages at other destinations, for example, and determines the average as the time required at the destination at which no packages have been transported in the past, and also uses this required time to create and change the flight plan information.

Changing unit 16 changes the flight plan so that drone 10 does not pass through any of the plurality of waypoints (destinations A, B, C, etc. in FIG. 9) through which drone 10 is scheduled to pass. However, drone 10 must eventually return to the base, and therefore a segment corresponding to the return to base P, such as the last segment S10, is left. For example, when it is assumed that the current time is the flight start time, as shown in FIG. 9, the flight plan is not changed if remaining time LTa is no less than scheduled time FT (FT=T11+T12+T21+T22+ . . . . T100) of the flight plan. On the other hand, the flight plan is changed in units of segments if remaining time LTb is less than scheduled time FT of the flight plan.

In the case shown in FIG. 9, remaining time LTb is no less than the time required for the segments from segment ID “S01” to segment ID “S03”, but is less than the time required for the segments from segment ID “S01” to segment ID “S04”. Therefore, the segments from segment ID “S04” to segment ID “S09” (not shown) are deleted, and, in the flight plan after the segments from segment ID “S04” to segment ID “S09” (not shown) are deleted, the segment with segment ID “S10” is changed to a segment corresponding to a flight plan from the final destination C of the segment with segment ID “S03” to base P. At this time, the segments to be deleted are deleted in a certain priority order. This priority order is, for example, the ascending order of scheduled flight times in the flight plan, the descending order of tolerance levels for package transport delays, or the order specified in advance by the administrator.

The changed flight plan information is stored in storage unit 12, and is also transmitted to and stored in server apparatus 50. Thereafter, flight control unit 13 controls the flight of drone 10 in accordance with the changed flight plan information.

### Operations

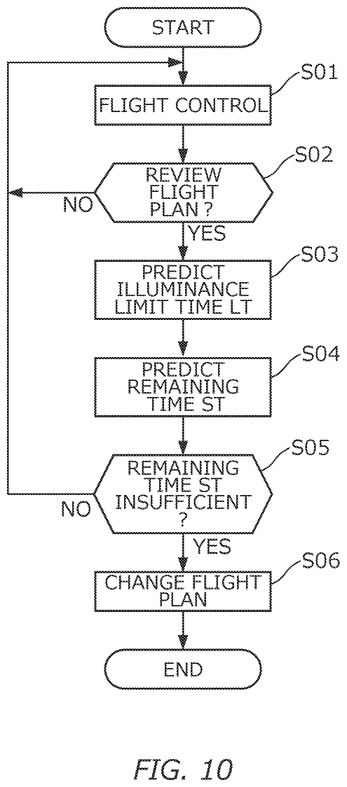

Next, processing performed when drone 10 flies will be described with reference to the flowchart shown in FIG. 10. In FIG. 10, drone 10 starts flying from the base, and flies under the control of flight control unit 13 (step S01).

For example, when the time to review the flight plan is reached, such as when a predetermined time has elapsed, when the flight corresponding to one segment is complete, or when an instruction is provided from server apparatus 50 (step S02; YES), prediction unit 14 predicts illuminance limit time LT at which the illuminance of the area in which drone 10 flies falls below the threshold value according to the above-described method, based on the illuminance acquire by acquisition unit 11 (step S03).

Furthermore, prediction unit 14 predicts remaining time ST from current time NT to illuminance limit time LT, using illuminance limit time LT in accordance with the above-described method (step S04).

Next, comparison unit 15 compares remaining time ST predicted by prediction unit 14 with future scheduled flight time FT included in the flight plan information for drone 10 in accordance with the above-described method.

If remaining time ST is insufficient compared to future scheduled flight time FT (step S05; YES), changing unit 16 changes the flight plan information for drone 10 in accordance with the above-described method so that future scheduled flight time FT is no greater than remaining time ST (step S06). On the other hand, if remaining time ST is sufficient with respect to future scheduled flight time FT (step S05; NO), processing returns to step S01.

The changed flight plan information is stored in storage unit 12, and is also transmitted to and stored in server apparatus 50. Thereafter, flight control unit 13 controls the flight of drone 10 in accordance with the changed flight plan.

According to the embodiment described above, the drone can fly in accordance with the time until the illuminance in flight becomes insufficient.

### Modifications

The present invention is not limited to the above-described embodiment. The above-described embodiment may be modified as described below. In addition, two or more of the modifications described below may be implemented in combination.

### Modification 1

The method by which prediction unit 14 predicts illuminance limit time LT is not limited to the example described in the embodiment. For example, prediction unit 14 may store the estimated time of sunset for each day on the calendar, and set the estimated time of sunset on the day drone 10 is flying as illuminance limit time LT. However, this illuminance limit time LT may change due to the influence of the weather, and therefore, prediction unit 14 may correct the estimated time of sunset (i.e., illuminance limit time LT) using the method described with reference to FIG. 6.

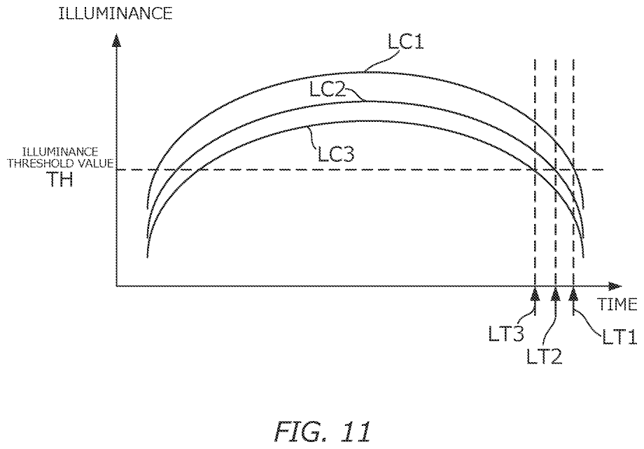

In addition, in this correction, instead of the illuminance detected by drone 10, an illuminance curve may be prepared for each weather, as illustrated in FIG. 11, and prediction unit 14 may use the illuminance curve corresponding to the weather in the area in which drone 10 flies, to predict the illuminance limit time. In the example in FIG. 11, illuminance curve LC1 is an illuminance curve when the weather is clear, and the illuminance limit time is LT1. Illuminance curve LC2 is an illuminance curve when the weather is cloudy, and the illuminance limit time is LT2. Illuminance curve LC3 is an illuminance curve when the weather is rainy, and the illuminance limit time is LT3. Prediction unit 14 obtains a weather forecast for the area in which drone 10 will fly, from, for example, an apparatus that provides weather forecasts (such as a web server), and predicts the illuminance limit time using an illuminance curve corresponding to the weather forecast. In this way, prediction unit 14 may predict the illuminance limit time using information regarding the weather in the area in which drone 10 flies. Note that more illuminance curves may be prepared, for example, for each proportion of clouds in the sky, as the plurality of illuminance curves illustrated in FIG. 11.

Note that prediction unit 14 may use any of the plurality of methods described in the embodiment and the above modifications, or may use the plurality of methods in combination.

### Modification 2

Drone 10 can fly relatively safely at an illuminance below illuminance threshold value TH by, for example, turning on a light or using an infrared camera. Therefore, even if remaining time ST is considered insufficient for future scheduled flight time FT, changing unit 16 may change the flight plan based on the increased power consumption resulting from drone 10 continuing to fly at an illuminance below illuminance threshold value TH. Specifically, changing unit 16 calculates the power consumption required for drone 10 to fly after illuminance limit time LT for each segment in the flight plan information based on a predetermined calculation formula, and changes the flight plan information to flight plan information in which some segments are deleted so that the total power consumption of drone 10 after the current time is no greater than the remaining battery power of drone 10. However, at this time, from a safety perspective, changing unit 16 may subtract a predetermined margin from the remaining battery power and compare the total power consumption of drone 10 after the current time with such a remaining battery power. In this way, the changing of the flight plan may include changing to a flight plan that is based on the increased power consumption resulting from drone 10 flying at an illuminance below illuminance threshold value TH.

### Modification 3

It is conceivable that drone 10 transporting a package transfers the task of transporting the package to equipment or an apparatus that transports packages on the ground. Therefore, if remaining time ST is considered insufficient compared to future scheduled flight time FT, changing unit 16 may change the flight plan to a flight plan in which drone 10 flies to an alternative transportation base that has equipment or an apparatus for transporting packages on the ground. Specifically, the position of each alternative transportation base may be stored, and changing unit 16 may calculate the time required for drone 10 to move to each alternative transportation base, and change the flight plan information to flight plan information that includes transportation of the package to such an alternative transportation base. In this way, the changing of the flight plan may include changing to a flight plan in which drone 10 flies to an alternative transportation base for the transportation of the package to be transported by drone 10 on behalf of drone 10.

### Modification 4

The time required for delivery at each destination illustrated in FIG. 9 (i.e., the time required to deliver the package to be transported by drone 10, from the area above the destination to the destination) varies depending on the method used to deliver the package, such as leaving the package at the entrance or balcony at the destination, or calling a user who is at home at the destination and delivering the package directly. Therefore, changing unit 16 may change the flight plan based on the method for delivering the package to be transported by drone 10, to the destination. Specifically, the expected times required for these methods are determined in advance for each method, and changing unit 16 changes the flight plan using the required times.

### Modification 5

The time required for delivery at each destination illustrated in FIG. 9 (i.e., the time required to deliver a package to be transported by drone 10, from the area above a destination to the destination) varies depending on the attribute of the destination to which the package is to be delivered, such as a detached house, a room in an apartment, a factory, or a warehouse. Therefore, changing unit 16 may change the flight plan based on the attribute of the destination of the package to be transported by drone 10. Specifically, the expected times required at the destinations are determined in advance based on the attributes of the destinations, and changing unit 16 changes the flight plan using the required times.

### Modification 6

The illuminance detection means for detecting the illuminance of the area in which drone 10 flies is not limited to the illuminance sensor included in drone 10, but may be an illuminance sensor installed on the ground in each area, for example.

### Modification 7

Landing control for the drone may be realized using so-called edge computing (control by the drone) described in the embodiment, cloud computing (control by the server apparatus), or the cooperation of both (control by the drone and the server apparatus). Therefore, the information processing apparatus according to the present invention may be included in server apparatus 50.

### Modification 8

The above embodiment is described based on an example of a flight vehicle (drone 10) that transports a package. However, the present invention is applicable to flight plans in which the flight vehicle lands at a destination without holding a package, and then takes off to the next destination with a package received and held at the landing position. In other words, the present invention is applicable to flight plans that include some sort of waypoint. In addition, the flight purpose or use of the flight vehicle is not limited to transporting a package as illustrated in the embodiment, but may be any other purpose, such as measuring or photographing some sort of object. In other words, the present invention is applicable to flight plans for the flight vehicle, regardless of the flight purpose or use of the flight vehicle. In addition, the flight vehicle is not limited to what is called a drone, and may have any shape or mechanism as long as it is a flight vehicle.

### Other Modifications

The block diagrams used in the description of the above embodiment show blocks in functional units. These functional blocks (components) are realized by a combination of hardware and/or software. Furthermore, there are no particular limitations on the means for realizing the functional blocks. In other words, the functional blocks may be realized by one physically and/or logically combined apparatus, or a plurality of physically and/or logically separated apparatuses that are connected directly and/or indirectly (for example, in a wired and/or wireless manner). For example, the functions of user terminals 30 to 32 illustrated in the embodiment may be provided in one computer. In short, each of the functions illustrated in FIG. 4 may be provided in any of the apparatuses constituting drone management system 1, which is an information processing system. For example, if server apparatus 50 can directly control drone 10, server apparatus 50 may be provided with a function equivalent to the processing unit, and directly restrict the flight of drone 10.

The aspects/embodiments described in the present description may be applied to a system that uses LTE (Long Term Evolution), LTE-A (LTE-Advanced), SUPER 3G, IMT-Advanced, 4G, 5G, FRA (Future Radio Access), W-CDMA (registered trademark), GSM (registered trademark), CDMA2000, UMB (Ultra Mobile Broadband), IEEE 802.11 (Wi-Fi), IEEE 802.16 (WiMAX), IEEE 802.20, UWB (Ultra-Wide Band), or Bluetooth (registered trademark), or another appropriate system, and/or a next-generation system that is an extension of any of these systems.

The orders in the processing procedures, sequences, flowcharts, and the like of the aspects/embodiments described in the present description may be changed as long as no contradictions arise. For example, the methods described in the present description show various step elements in an exemplified order, and are not limited to the specific order that is shown. The aspects/embodiments described in the present description may be used alone or in combination, or may be switched when they are implemented. Furthermore, the notification of predetermined information (e.g., notification of “being X”) is not limited to being performed explicitly, and may also be performed implicitly (for example, notification of the predetermined information is not performed).

The information and the parameters described in the present description may also be expressed as absolute values, relative values with respect to a predetermined value, or another type of information corresponding thereto.

The term “determining” used in the present description may include various types of operations. For example, the term “determining” can include a case where judging, calculating, computing, processing, deriving, investigating, looking up (for example, looking up a table, a data base, or another data structure), or ascertaining is regarded as “determining”. Furthermore, the term “determining” can include a case where receiving (for example, receiving information), transmitting (for example, transmitting information), inputting, outputting, or accessing (for example, accessing data in the memory) is regarded as “determining”. Furthermore, the term “determining” can include a case where resolving, selecting, choosing, establishing, or comparing is regarded as “determining”. In other words, the term “determining” can include a case where some operation is regarded as “determining”.

The present invention may be provided as an information processing method or a program. This program may be provided in a mode of being recorded on a recording medium such as an optical disk, or may be provided in a mode of being downloaded to a computer via a network such as the Internet and being installed in the computer to become usable, for example.

Software, instructions, and the like may also be transmitted/received via a transmission medium. For example, if software is transmitted from a web site, a server, or another remote source using a wired technology such as a coaxial cable, an optical fiber cable, a twisted-pair wire, or a digital subscriber line (DSL), and/or a wireless technology using infrared light, radio waves, microwaves, or the like, the definition of the transmission medium will include the wired technology and/or the wireless technology.

Information, signals, and the like described in the present description may also be expressed using any of various different technologies. For example, data, an instruction, a command, information, a signal, a bit, a symbol, a chip, and the like that can be mentioned throughout the entire description above may also be expressed by an electric voltage, an electric current, an electromagnetic wave, a magnetic field or a magnetic particle, an optical field or a photon, or a combination thereof.

All references to elements that have been given names such as “first” and “second” in the present description do not overall limit the number of such elements or the orders thereof. Such names may be used in the present description as a convenient method for distinguishing between two or more elements. Accordingly, references to first and second elements are not intended to mean that only two elements can be employed, or that the first element is required to come before the second element in some sort of manner.

The “means” in the configurations of the above-described apparatuses may be replaced with “unit”, “circuit”, “device”, or the like.

The terms “including”, “comprising”, and variations thereof are intended to be comprehensive as long as they are used in the present description or the claims, similar to the term “being provided with”. Furthermore, the term “or” used in the present description or the claims is intended not to be exclusive OR.

In the entirety of the present disclosure, when articles are added through translation, for example, as “a”, “an”, and “the” in English, these articles also denote the plural form unless it is clear otherwise from the context.

While the present invention has been described in detail, it would be obvious to those skilled in the art that the present invention is not limited to the embodiments described in the present description. The present invention can be implemented as corrected and modified aspects without departing from the spirit and scope of the present invention that are defined by the description of the claims. Accordingly, the present description aims to illustrate examples and is not intended to restrict the present invention in any way.

### REFERENCE SIGNS LIST

1: Drone Management System
10: Drone
11: Acquisition Unit
12: Storage Unit
13: Flight Control Unit
14: Prediction Unit
15: Comparison Unit
16: Changing Unit
30: User Terminal
40: Wireless Communication Network
50: Server Apparatus
1001: Processor
1002: Memory
1003: Storage
1004: Communication Apparatus
1005: Input Apparatus
1006: Output Apparatus
1007: Positioning Apparatus
1008: Sensor
1009: Flight Drive Mechanism
50: Server Apparatus
5001: Processor
5002: Memory
5003: Storage
5004: Communication Apparatus

1. An information processing apparatus comprising:
a prediction unit that predicts a time at which an illuminance of an area in which a flight vehicle flies will fall below a threshold value;
a comparison unit that compares a time remaining until the predicted time with a flight time scheduled after a current time included in a flight plan for the flight vehicle; and
a changing unit that changes the flight plan for the flight vehicle when the time remaining is insufficient compared to the scheduled flight time.

2. The information processing apparatus according to claim 1,
wherein the flight plan is changed to a flight plan in which the flight vehicle does not pass through any of a plurality of scheduled waypoints.

3. The information processing apparatus according to claim 1,
wherein the flight plan is changed to a flight plan in accordance with an increase in power consumption due to flight at an illuminance below the threshold value.

4. The information processing apparatus according to claim 1,
wherein the flight plan is changed to a flight plan in which the flight vehicle flies to an alternative transportation base for alternative transportation of a package being transported by the flight vehicle.

5. The information processing apparatus according to claim 1,
wherein the prediction unit predicts the time based on an illuminance of the area in which the flight vehicle flies, the illuminance of the area being detected by an illuminance detection means.

6. The information processing apparatus according to claim 1,
wherein the prediction unit predicts the time based on an estimated sunset time on a day when the flight vehicle flies.

7. The information processing apparatus according to claim 1,
wherein the prediction unit predicts the time using information on weather in the area in which the flight vehicle flies.

8. The information processing apparatus according to claim 1,
wherein the changing unit changes the flight plan based on recorded time required to deliver a package to be transported by the flight vehicle, from an above a destination to the destination.

9. The information processing apparatus according to claim 1,
wherein the changing unit changes the flight plan based on a method for delivering a package to be transported by the flight vehicle to a destination.

10. The information processing apparatus according to claim 1,
wherein the changing unit changes the flight plan based on an attribute of a destination of a package to be transported by the flight vehicle.
